(19) United States
(12) Patent Application Publication
(10) Pub. No.: US 2021/0198766 A1
(43) Pub. Date: Jul. 1, 2021

(54) SYSTEM AND METHOD FOR DRY ABLATION BENEFICATION OF ORE

(71) Applicant: HATCH LTD., Mississauga (CA)

(72) Inventors: David DELVES, Toronto, (CA); Mahdi MAHDI, Etobicoke (CA); Sabrina FRANCEY, Thornhill (CA); Yuhin WU, Unionville (CA); Santiago FAUCHER, Oakville (CA); Bruce UYEDA, Oakville (CA); Daniel MAJOR, Sevenoaks (GB); Kamal ADHAM, Toronto (CA)

(21) Appl. No.: 16/078,677

(22) PCT Filed: Aug. 15, 2018
(86) PCT No.: PCT/CA2018/050986

§ 371 Date: Aug. 22, 2018

(51) Int. Cl. C22B 1/243; C22B 26/12; C22B 60/02; B02C 23/14; B02C 19/06

(52) U.S. Cl. CPC C22B 1/243; C22B 26/12; B02C 19/068; B02C 23/14; C22B 60/0208

(57) ABSTRACT

A system and method for dry ablation beneficiation of ore. The system comprises a nozzle to emit an air stream, and a feeder to provide ore particles for entraining in the air stream and colliding. The ore comprises gangue grains bound together with a cementing material. The cementing material comprises a desired material. The collisions are controlled to help preferentially break the cementing material over breaking the bonds holding a gangue grain together. The system also comprises a classifier to separate broken cementing material from the remaining material (which includes gangue grains) based on size. The method comprises entraining the ore particles in an air stream and colliding to preferentially break the cementing material. The ore particles may be collided with each other or a surface. The broken cementing materials are then separated from the remaining materials (which includes gangue grains). The enriched ore is the separated cementing material.

### FIELD

The present disclosure relates to the enrichment of ore.

### BACKGROUND

Beneficiation of ore comprises separating the desired materials from at least some of the undesired materials in the ore. This enriches the ore by reducing the volume of undesired materials within the ore. For certain low-grade ore deposits, early beneficiation may be required to make it economical to mine and process. Low-grade ore deposits have very little desirable material relative to the amount of undesirable material by volume and/or weight.

FIG. 1 shows a representation of a low-grade, sandstone-hosted, ore deposit 100. The ore deposit 100 comprises a desired material (such as uranium-bearing minerals) 102 which is a sub-component of a cementing material 104. The cementing material 104 may also comprise one or more of carbonate, clay, and sulphate minerals. The cementing material 104 binds to larger gangue materials, namely, framework grains composed of quartz and/or feldspar 106.

The rejection of undesired gangue minerals from ores (such as the ore described in relation to FIG. 1) may allow for a number of benefits for downstream processes relating to the ore, such as reductions in cost for handling and transport, reductions in required equipment sizes (resulting in capital cost savings) and reductions in reagent consumption (resulting in operating cost savings).

Conventional separation processes for enrichment of ores and extraction of metals from ores may not be effective and/or economically viable for low-grade ores, including low-grade ores that comprise cementing materials that bind gangue grains as shown in FIG. 1. For example, leaching, gravity separation, and flotation may not be suitable, or may be complex and economically unviable due to the associated capital cost (e.g. equipment) and operating cost (e.g. materials and reagents). Furthermore, many of the conventional physical beneficiation processes for ore enrichment require significant quantities of water and have associated needs for liquid-solid separation, wet tailings management and water treatment, which incur additional costs. Significant water usage can also be challenging and costly at mine sites in water scarce areas.

An effective, economically viable system and method for enriching low-grade ores, including ores comprising a cementing material binding gangue grains, is desired.

### BRIEF DESCRIPTION OF THE FIGURES

FIG. 1 shows a representation of a portion of sandstone-hosted ore.

FIG. 2 shows a system for enriching ore using air streams according to an embodiment of this disclosure.

FIG. 3 shows another embodiment of a system for enriching ore using a single air stream and strike surface according to this disclosure.

FIG. 4 shows another embodiment of a system for enriching ore using an ablation unit with one or more air streams and a supporting infrastructure for material and gas handling.

FIG. 5 shows a more detailed front view of the ablation unit portion of a system that is similar to the system of FIG. 4

FIG. 6 shows a fluidized bed jet mill configured, according to an embodiment of this disclosure, to ablate ore.

### DETAILED DESCRIPTION

In an embodiment of the disclosure, ore particles comprising cementing material bound to gangue grains are processed by entraining in a gas stream and colliding. The collisions break the cementing material while minimizing breaking of the gangue grains. Breaking the cementing material comprises liberating cementing material from gangue grains by breaking the bonds holding the cementing material to the gangue grains, and/or breaking off portions of cementing material from other cementing material to reduce the overall particle size of the cementing materials. The smaller broken cementing material particles are then separated from the larger gangue grain particles based on their sizes to produce an enriched ore concentrate.

This dry ablation process takes advantage of the difference in forces required to break cementing materials and gangue grains. The bonds holding cementing material particle to a gangue grain may be weaker than the bonds holding a gangue grain together. Similarly, the bond between two cementing material particles may be weaker than the bond holding a gangue grain together. In an embodiment, ore particles are collided with the force required to break the bond between a cementing material particle and a gangue grain, and the force required to break the bond between two cementing material particles, but not the force required to break the bonds holding a gangue grain together. The force is created by accelerating the ore particles with air so that they have a select velocity at the time of collision. The collisions may be between ore particles of the same gas stream, or ore particles in different gas streams. The collisions may also be between ore particles of a gas stream and a strike surface. The gas stream(s) may be produced by one or more blower(s). To help avoid component wear, the ore particles may be provided into the gas stream after that gas stream has been accelerated, such as downstream from a nozzle emitting the accelerated gas stream. Alternatively, the ore particles may be introduced into the gas stream at any point along the stream, including after (i.e. downstream of) the blower but before (i.e. upstream of) the nozzle, and even before/upstream of the blower prior the gas stream passing through and being accelerated by the blower. The ore particles may be dropped into the gas stream from above. The smaller cementing material may be separated from the larger gangue grains using a device which separates based on particle size, such as a classifier (which includes sieves and screens). This dry ore ablation process may also be performed using a modified fluidized bed jet mill.

By not using water, the dry ablation process can be performed at a greater number of locations, and helps avoid downstream water and tailings treatments.

In an embodiment of the present disclosure, a method for enriching ore comprises providing a gas stream; providing ore particles into the gas stream, the ore particles comprising cementing materials bound to gangue grains; colliding the ore particles in the gas stream to break the cementing materials; and separating a fine fraction comprising the broken cementing materials, from a coarse fraction comprising the gangue grains. The method may further comprise providing a second gas stream, and providing ore particles into the second gas stream, wherein colliding the ore particles in the gas stream comprises colliding with the ore particles in the second gas stream. The method may further comprise providing a strike surface, and wherein colliding the ore particles in the gas stream comprises colliding the ore particles with the strike surface. Colliding the ore particles may comprise colliding the ore particles with each other. The method may further comprise stopping collision of the ore particles in response to reaching a threshold rate of production of the fine fraction. Ore particles may be provided into the gas stream after acceleration of the gas stream. The method may further comprise emitting the gas stream from a nozzle, and providing the ore particles into the gas stream downstream from the outlet of the nozzle. The ore particles may be provided into the gas stream using the force of gravity. The fine fraction may be separated from the coarse fraction based on a difference in particle sizes. The fine fraction may be separated from the coarse fraction using a classifier. Providing ore particles into the gas stream may comprise providing the coarse fraction of the ore particles back into the gas stream. Providing the gas stream may comprise accelerating the gas stream to a velocity that is less than a threshold velocity required to break the bonds holding at least a portion of the gangue grains together when colliding the ore particles in the gas stream.

In another embodiment of the present disclosure, an ore ablation system comprises: a feeder configured to provide ore particles, the ore particles comprising a cementing material bound to gangue grains; a nozzle configured to provide a first gas stream which collides the ore particles entrained within the first gas stream to break the cementing materials; and a classifier configured to separate a fine fraction comprising the broken cementing material, from a coarse fraction comprising the gangue grains. The ore ablation may also comprise an enclosure for receiving the ore particles and the first gas stream. The ore ablation system may also comprise a second nozzle configured to provide a second gas stream that intersects with the path of the first gas stream to collide the ore particles entrained within the first and second gas streams. The ore ablation system may also comprise a strike surface positioned within the path of the first gas stream. The ore ablation system may also comprise a blower configured to provide the first gas stream to the nozzle. The feeder may be configured to provide the ore particles into the first gas stream downstream of the nozzle. The feeder may be configured to provide the ore particles into the first gas stream upstream of the nozzle. The classifier may be a static classifier or a dynamic classifier. The outlet of the feeder may be positioned above the first gas stream. The ore ablation may also comprise a coarse material handling system configured to return the coarse fraction back into the feeder.

In another embodiment of the present disclosure, a fluid bed jet mill comprises a fine particle monitor, wherein the fluid bed jet mill configured to take an action in response to detecting, using the monitor, a threshold production rate of fine particles. The threshold production rate of fine particles may be a lower threshold production rate of fine particles. The monitor may be located downstream of the classifier. The fluid bed jet mill may be configured to take the action of allowing coarse ore particles to exit the fluid bed jet mill through an outlet in response to detecting the threshold production rate. The fluid bed jet mill may be configured to take the action of opening an outlet in the fluid bed jet mill in response to detecting the threshold production rate. The fluid bed jet mill may be configured to take the action of ceasing its operation in response to detecting the threshold production rate. The fluid bed jet mill may be configured to take the action of slowing its operation in response to detecting the threshold production rate. The monitor may comprise a load cell configured to measure the weight of fine particles produced by the fluid bed jet mill. The fluid bed jet mill may be configured to determine the rate of fine particle production based on the rate of change of the weight of fine particles detected by the load cell. The load cell may be located in a bag house. The monitor may be an opacity monitor configured to detect the density of fine particles in a gas stream of the fluid bed jet mill. The opacity monitor may be located immediately after the classifier. The opacity monitor may be located within the classifier.

In another embodiment of the present disclosure, a method for enriching ore particles comprises: providing the ore particles into a fluid bed jet mill, the ore particles comprising cementing materials bound to gangue grains; preferentially milling the cementing materials rather than the gangue grains in the fluid bed jet mill; and passing a fine fraction comprising the broken cementing material through a classifier. The method may also comprise slowing or stopping the operation of the fluid bed jet mill. The method may also comprise removing a coarse material from the mill. The coarse material may be removed from the mill in response to reaching a threshold period of time. The coarse material may be removed from the mill in response to reaching a threshold production rate of the fine fraction. The fluid bed jet mill operation may be slowed or stopped in response to reaching a threshold period of time. The fluid bed jet mill operation may be slowed or stopped in response to reaching a threshold fine fraction production rate. The production rate of the fine fraction may be a lower threshold production rate. The method may comprise monitoring the fine fraction. The rate of production of the fine fraction may be monitored. The fine fraction may be monitored with a load cell. The fine fraction may be monitored with an opacity monitor. The rate of fine fraction production may be determined based on the rate of change of the weight of fine particles. The rate of fine fraction production may be determined based on the opacity of an air stream containing the fine fraction. The fine fraction may be monitored within the classifier. The fine fraction may be monitored immediately downstream of the classifier. The fine fraction may be monitored in a bag house. Preferentially milling the cementing materials may comprise controlling the operation of the fluid bed jet mill to collide the ore particles with each other in the fluid bed jet mill at a velocity that is less than a threshold velocity required to break the bonds holding together at least a portion of the gangue grains.

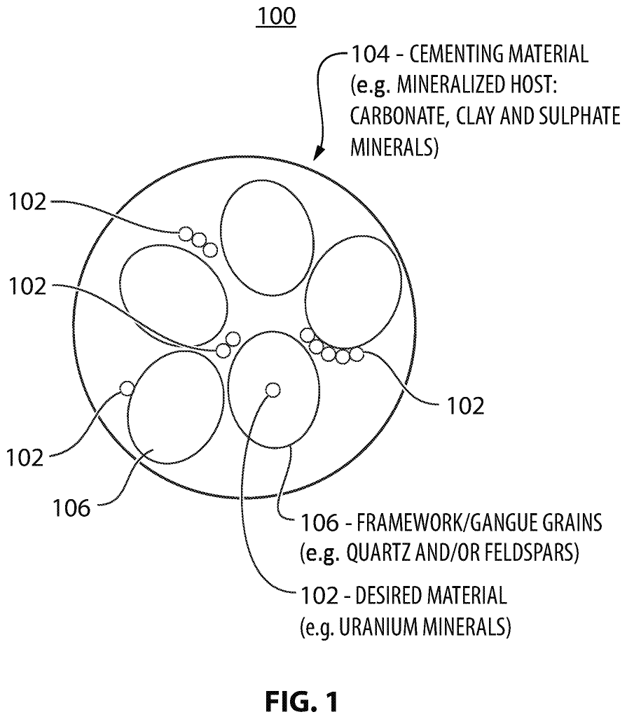

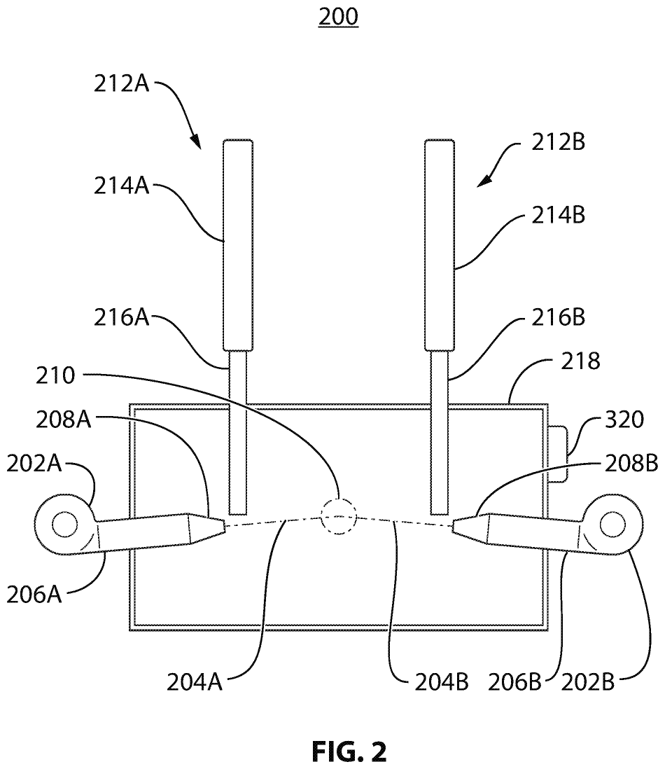

FIG. 2 shows a system 200 for enriching ore according to an embodiment of this disclosure. The system 200 comprises an air supply provided by two blowers 202A, 202B. Each blower 202A, 202B is connected to a respective conduit 206A, 206B, and nozzle 208A, 208B. The blowers 202A, 202B accelerate air streams 204A, 204B which enter the blowers 202A, 202B, pass through their respective conduits 206A, 206B, and exit their respective nozzles 208A, 208B. The nozzles 208A, 208B are spaced from each other by a distance and arranged so that each of their air streams 204A, 204B intersect in an area defining a collision zone 210. The speed/velocity of each of the air streams at the point they exit the nozzles may be greater than or equal to 40 meters per second (m/s). A blower may be configured to accelerate a gas stream to a velocity that is less than the threshold velocity required to break the bonds within at least some of the gangue grain particles when colliding the ore particles in the gas steam. The velocity an ore particle requires at the time of collision to break the cementing material without breaking the bonds holding a gangue grain together is dependent on the type of ore. That velocity may be between 40 meters per second (m/s) and 500 m/s for a sandstone hosted ore, similar to the ore shown in FIG. 1. The nozzles 208A, 208B may be pointed at each other so that their outlets are opposing. Or the nozzles 208A, 208B may be arranged so that the paths of the air streams 204A, 204B the nozzles are providing are at an angle to one another. A nozzle can be any type of orifice through which a gas may pass.

The system 200 also comprises feeders 212A, 212B which help provide ore particles into the air streams 204A, 204B. The feeders may be conduits having outlets positioned adjacent to the air streams. The feeders 212A, 212B of FIG. 2 comprise hoppers 214A, 214B connected to pipes 216A, 216B, respectively. Ore is fed into the hoppers 214A, 214B, descends down the pipes 216A, 216B, and exits from the outlets of the pipes 216A, 216B into the paths of the air streams 204A, 204B as a stream of feed material. The ore material may descend down the hoppers 214A, 214B and pipes 216A, 216B through the force of gravity, alone. A feeder may also comprise other mechanical elements (such as augers and/or conveyors) to provide the ore into the paths of the air streams. The ore particles that are placed within the feeders 212A, 212B are sufficiently small to be entrained in the air streams 204A, 204B. The ore particles may have a diameter of 5 millimeters or less.

The outlets of the feeders 212A, 212B may be positioned directly above a point along the paths of the air streams 204A, 204B so that ore particles fall from those outlets into the air streams 204A, 204B as a result of the force of gravity. The vertical displacement/distance between the air streams and the outlet of the feeders may be minimized to reduce the extent of freefall acceleration experienced by the ore particles due to the force of gravity. This is because ore particles which enter the air stream at too high of a velocity may inadvertently pass through the entire air stream so as not to become entrained therein. Some vertical displacement between the air stream and the outlet of the feeders may be desired to help avoid wear on the outlets of the feeders due to contact with accelerated ore particles. Similarly, the horizontal displacement between the outlets of the nozzles and the outlets of the feeders may be minimized to help ensure the ore particles interact with the focused portion of the air stream immediately after it exits the nozzles and before that air disperses and its velocity decreases. Some horizontal displacement between the nozzle outlets and the outlet of the feeders may also be desired to help avoid wear on the nozzles due to interaction with the ore particles.

The ore particles may be fed into the air stream in a manner to help more evenly distribute the ore particles across the width of the air streams. Doing so may help create a relatively dense phase of ore particles in the air stream to more efficiently use the air stream, and to potentially increase the overall probability of ore particles experiencing collisions in the collision zone 210. Controlling the air to solids (i.e. ore particles) ratio can help reduce the volume of air required to entrain and accelerate ore particles. Reducing air volume requirements helps reduce cost by allowing for smaller size air supply and handling equipment. For example, the air to solids ratio may be between 10 and 2000 m³ air per ton of ore (air/t), where the suitable ratio is dependent on several factors, including solids properties. One way to affect the air to solids ratio is by controlling the rate at which ore particles are provided into the air streams (also referred to as the flow rate). The rate may be selected to optimize the proportion of particles that actually become entrained in the air streams.

During the ablation process, each of the feeders 212A, 212B provide ore particles into their respective air streams 206A, 206B. At least some of the ore particles exiting the feeders 212A, 212B become entrained in the respective air streams 216A, 216B. Where the particles become entrained depends on where they are provided into the gas stream. For example, the particles may be provided into the gas stream before they enter the blowers. The force of the air streams 204A, 204B accelerate the entrained ore particles so as to carry those particles along the air stream paths and into the collision zone 210 with a certain amount of kinetic energy. The ore particles in each of the air streams 204A, 204B collide with each other in the collision zone 210. The collisions between the particles preferentially break the cementing material rather than the gangue grains. Breaking the cementing material includes liberating the cementing material from the gangue grains by breaking the bonds holding the cementing material to the gangue grains. Preferentially breaking the cementing material over the gangue grains includes breaking the bonds holding cementing material together, while minimizing breaking of the bonds holding gangue grain particles together. Although the bonds which hold a gangue grain particle together may be broken for some of the gangue grain particles, the desire is to more frequently break the cementing material than break the bonds holding a gangue grain together. This both liberates the cementing material from the gangue grains, and reduces the size of the cementing material particles so that they become smaller than the gangue grains.

Due to the collisions, the desired material (uranium minerals, for example) reports to the fine fraction as a component of at least a portion of the broken cementing material, while the gangue grains remain relatively intact. The coarse fraction comprises at least a portion of the gangue grains (including any unliberated cementing material remaining on those grains), and cementing material particles that are still around the size of the gangue grains or larger. The fine fraction can be separated from the coarse fraction based on the differences in the sizes of the particles in each fraction. This separation can be performed with any devices that discriminate based on particle size, such as classifiers including sieves and screens. The fine fraction, containing the majority of the desired material, is the enriched ore concentrate.

As previously discussed, the ore particles may have a diameter of 5 millimeters or less prior to their introduction into an air stream. The ore may be ground or crushed to achieve the desired ore particle diameter range. Preferably, the crushing and/or grinding minimizes the production of particles that are less than the threshold size used to separate the fine fraction of the ore material from the coarse fraction of the ore material. If gangue grain particles are smaller than the threshold size at the start of the ablation process, they will report to fine fraction thereby reducing the concentration of the desired material in the enriched ore. The threshold particle separation size is dependent on the type of ore being processed. The threshold particle separation size may be between 5 and 250 microns for a sandstone hosted ore, similar to as shown in FIG. 1.

The goal of the dry ablation process is to liberate the cementing material from the gangue grains and reduce the size of the cementing material particles, without reducing the size of the gangue grains.

In an embodiment, the fine fraction (also referred to herein as the fine material) is removed from the system 200, and the coarse fraction (also referred to herein as coarse material) is provided back into one or more of the air streams 204A, 204B for further ablation to enhance recovery of the desired materials. An ore particle may need to experience multiple collisions to recover a sufficient proportion of the desired material from that ore particle through this ablation process. Due to gravity, some of the coarse material may fall down to the surface below the air stream 204A, 204B. That coarse material may be returned back into the air stream(s) 204(a), 204(b) for further ablation. In an embodiment, the coarse material is collected and provided back into the air stream(s) 204A, 204B via the feeder(s) 212A, 212B to undergo further collisions. This is also referred to as re-circulating the coarse material. The coarse material may comprise ore particles that have experienced one or more collisions, as well as ore particles that have not yet experienced any collisions.

The system 200 may be configured in various ways to suit the application. For example, the system 200 may be configured to suit the ore being processed. In an embodiment, the collision zone 210 is constrained to increase the likelihood that the particles collide with one another. The collision zone may be constrained by, for example, limiting the height (depth) of the nozzle outlet, limiting the width of the nozzle outlet, limiting the width of the stream of feed material, limiting the distance between the outlets of the nozzles to constrain the extent to which air within the streams disperse, or limiting the regions where the air and the feed material meet (with a constraining physical enclosure for example). The distance between the outlets of the nozzles 208A, 208B, and the velocities of the air streams 204A, 204B may be selected to control the amount of kinetic energy the ore particles have at the time of collision.

The amount of kinetic energy of the particles at the time of collision may be selected to control (a) the extent to which and/or the rate at which the cementing material is liberated from the gangue grains, and (b) the amount of breakage experienced by each of the cementing materials and gangue grains. A higher kinetic energy may result in more cementing material being liberated from the gangue grains with each collision of an ore particle, and/or cementing material being liberated from gangue grains at a faster rate generally. A higher kinetic energy may also result in a greater amount/rate of breakage of cementing material particles thereby reducing their size. But a higher kinetic energy may also cause more gangue grains to break apart, and/or increase the rate at which the gangue grains are broken apart relative to the rate at which cementing materials are broken apart and/or cementing materials are liberated. The amount of kinetic energy of ore particles at the time of collision may, accordingly, be controlled to achieve the desired results for a particular application. For example, in some applications it may be desirable to more quickly liberate the cementing materials from the gangue grains by providing ore particles with a higher kinetic energy, even though this results in a greater amount of gangue grain particles reporting to the fine fraction. The amount of kinetic energy of the particles at the time of collision may be selected according to the velocity of the air streams. The velocity of an air stream may depend on a number of factors, including the rate at which the air of the air stream is expelled by a blower, the size of orifice/outlet of the nozzle, and the distance of the orifice/outlet from the collision zone.

The angle of the paths of the air streams 204A, 204B relative to each other may also be selected to control (a) the extent to which and/or the rate at which the cementing material is liberated from the gangue grains, and (b) the amount of breakage experienced by each of the cementing materials and gangue grains. Selecting the angle of the paths of the air streams 204A, 204B may help control the incident angle at which ore particles collide. The closer that angle is to 180 degrees, the greater the force of impact experienced by ore particles when they collide, on average.

As shown in FIG. 2, the hoppers 212A, 212B provide the ore particles directly above the air streams 204A, 204B immediately after (i.e. downstream from) the outlets of the nozzles 208A, 208B. The force of gravity causes those ore particles to descend into the paths of the air streams 204A, 204B so that at least some of those particles become entrained in the air streams. In an alternative embodiment, the ore particles are introduced into the air streams before (i.e. upstream from) the outlets of the nozzles 208A, 208B. For example, the ore particles may be introduced at the air intake of the blower 202A, 202B, or at a point along the conduits 206A, 206B. Introducing the ore particles into the air stream downstream from the nozzles 208A, 208B, however, helps avoid wear and contamination of the components used to accelerate and direct the air streams, including the blower, the interior surfaces of the conduits, and the nozzles. This is especially important for ore particles comprising silica gangue grains due to their abrasiveness. Reducing wear on components also helps reduce contamination of the enriched ore.

Instead of two blowers, the system 200 may have a single blower which is connected via a manifold to each of the conduits 206A, 206B, or connected directly to the nozzles 208A, 208B. The system 200 may comprise an enclosure 218 which surrounds at least the collision zone 210. The enclosure 218 may also surround other portions of the system 200. The enclosure may receive the ore particles and the gas stream(s) separately, or it may receive the gas stream(s) already entrained with the ore particles. The materials can also be provided into the air streams 204A, 204B through other means, including a belt feeder, screw conveyers, etc. The air streams 204A, 204B may comprise atmospheric air or other gas(es). The angles and distances of the nozzles relative to each other may be selected. The impact zone 210 may be constrained to increase the likelihood of collisions between particles. Although two air streams and nozzles are shown in the system 200 of FIG. 2, multiple air streams may be provided, each air stream having a path that intersects with the path of one or more of the other air streams to define one or more collision zones. Each of the air streams may be emitted from its own respective nozzle.

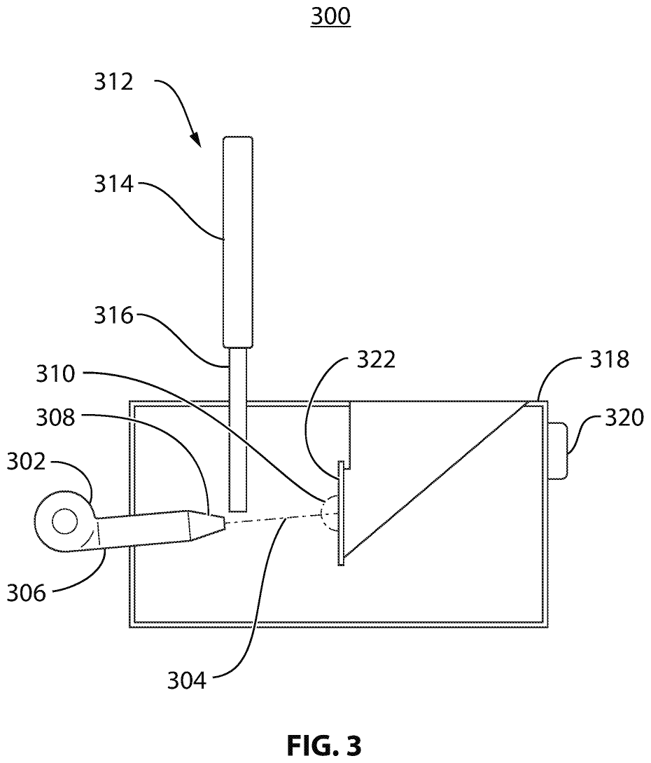

FIG. 3 shows another embodiment of a system 300 for enriching ore according to this disclosure. The system 300 is similar to the system 200 of FIG. 2, the difference being that the system 300 of FIG. 3 comprises a strike surface 322 against which the ore particles in an air steam 304 are collided, rather than another air stream with entrained ore particles travelling in an opposite direction. The strike surface 322 is positioned within the path of the first gas stream. The distance and/or angle of the strike surface relative to the nozzle outlet 302 may be selected to help control the range of velocities and/or angles at which the ore particles contact the strike surface 322. As shown in FIG. 3, the strike surface 322 is a strike plate.

A strike surface 322 may increase the likelihood that each ore particle entrained in the air stream experiences a collision. In the system 200 of FIG. 2, there is no guarantee that any particular ore particle entrained in the air stream will experience a collision, or a collision with sufficient energy to liberate cementing material from gangue grains or break apart the cementing material. An ore particle may simply not hit any other ore particle in the collision zone 210. A collision between two ore particles is a probabilistic occurrence. Similar to the ablation process of the system 200 of FIG. 2, the fine material is separated from the coarse material as enriched ore concentrate. In an embodiment, the fine material is removed from the system 300, and the coarse material is provided back into the air stream 304 for further ablation to enhance recovery of the desired materials. Ore particles may need to experience multiple collisions to recover a sufficient proportion of the desired material within those ore particles. Due to gravity, some of the coarse material may fall down to the surface below the air stream 304. That coarse material may be collected and re-fed back into the air stream 304 via the feeder 312.

The strike surface 322 will experience wear so may need replacement on occasion. Due to wear, the material of the strike surface 322 may contaminate the enriched ore. To help avoid such contamination, the material of the strike surface 322 is preferably a wear-resistant material.

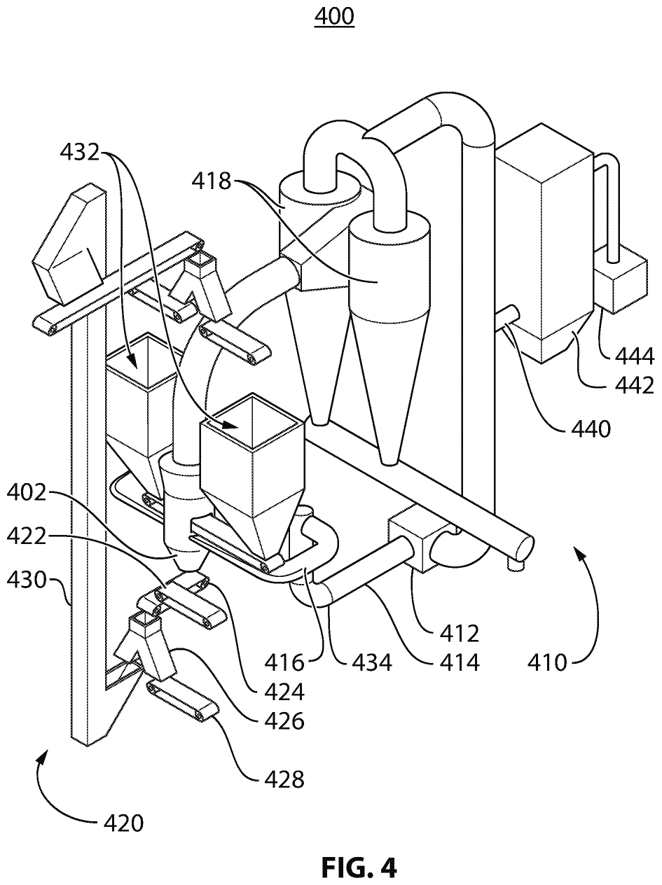

FIG. 4 shows a system 400 according to another embodiment of the present disclosure. The system 400 comprises an ablation unit 402 for ablating ore particles and a supporting infrastructure for material and gas handling. The supporting infrastructure helps introduce ore into the ablation unit 402 for processing, and move materials about the system/remove materials from the system, that have been processed by the ablation unit 402. The supporting infrastructure of the system 400 comprises a gas and fine material handling system 410, and a coarse material handling system 420.

During operation of the system 400, the coarse material handling system 420 provides ore material into the ablation unit 402 to be processed. The coarse material handling system 420 comprises a fresh feed conveyor 422 which introduces new ore material for processing to a first conveyor belt 424. The fresh feed conveyor 422 introduces new ore material at least at the beginning of an ore processing cycle. The fresh feed conveyor 422 may also introduce new ore material during a cycle. The first conveyor belt 424 moves the ore material into a chute 426 which can be controlled to either direct the ore material onto a waste conveyor belt 428 to remove the ore material from the system 400 entirely, or place in a bucket elevator 430 for eventual re-entry into the ablation unit 402. The bucket elevator 430 raises the ore to the top of the system 400. The ore then enters the tops of the feed hoppers 432. The ore emerges from the bottoms of the feed hoppers 432 and is fed into the ablation unit 402 using belt feeders 434. The feed hoppers 432 may provide a buffer of material to help avoid inconsistent provision of material to the belt feeders 434, which would lead to inconsistencies in the rate at which ore material is introduced into the ablation unit 402. The feed hoppers 432 may be tapered at their bottoms to help with withdrawal of the ore. The speed of the belt feeders 434 may control the rate at which ore material is introduced into the ablation unit 402.

The ablation unit 402 receives accelerated air from a gas and fine material handling system 410. The accelerated air may be created through releasing pressurized air. This system 410 creates the accelerated air using a blower 412. The accelerated air is provided into the air ablation unit 402 at two different locations via a conduit 414 connected to a manifold 416. The air streams intersect in the ablation unit 402 to define a collision zone. In the ablation unit 402 the ore particles are provided into the air streams. This accelerates the ore particles and causes them to collide.

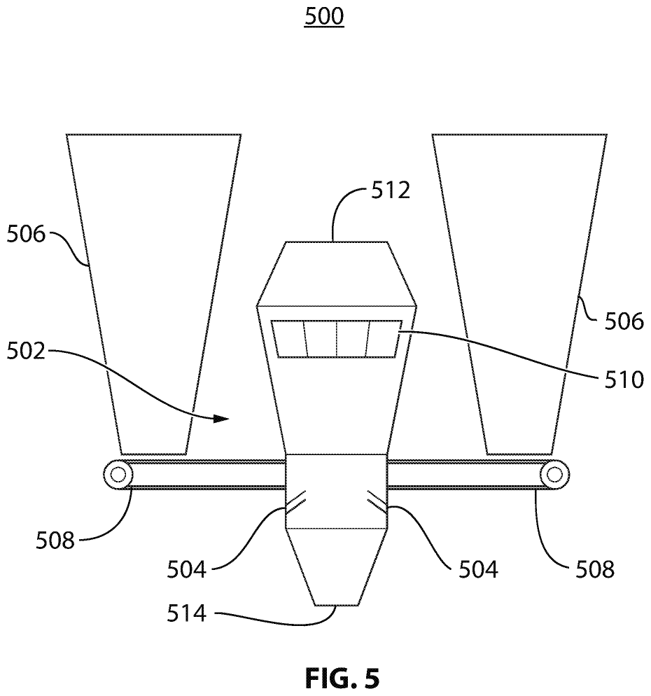

FIG. 5 shows a more detailed front view of an ablation unit portion of a system 500 which is similar to the system 400 of FIG. 4. The ablation unit 502 provides an enclosure comprising inlets 504 for receiving air. The air may be accelerated prior to being received by the ablation unit 502 at the inlets 504. For example, the accelerated air may come from an external blower (as shown in FIG. 4). Alternatively, the air may be accelerated at the ablation unit 502 at or after the inlets 504. The inlets 504 direct the air to nozzles to produce air streams within the ablation unit 502. Belt feeders 508 move ore particles from the bottom of the feed hoppers 506 into the ablation unit 502, and provide the ore particles in the air streams therein. The belt feeders 508 may drop the ore particles from above the air streams so they fall into the air stream under the force of gravity. The air streams accelerate at least a portion of the ore particles causing them to collide with one another within the ablation unit 502. The ablation unit 502 also comprises an integral classifier 510. The integral classifier 510 separates ore particles having a size less than or equal to a threshold size and allows those ore particles to exit from the ablation unit 502 via the off-gas and fines outlet 512. All other particles in the ablation unit 502 emerge from the coarse outlet 514 at the bottom of the unit 502. The integral classifier 510 may be configured to only remove ore particles having a size equal to or less than the average size of gangue grains in the ore being processed. For example, the integral classifier 510 may be configured to remove ore particles having a size that is less than 80% of the size of the average gangue grains in the ore being processed. In this way, at least a portion of the gangue grains are separated from the ore comprising the desired material. The threshold size selected for the integral classifier may be determined through experimentation. The threshold size may be selected to obtain the desired balance between desired material yield, and mass rejection of gangue material.

Referring again to FIG. 4, the fines and off-gas (air) from ablation unit 402 are removed from the top of the unit 402 by the gas and fine material handling system 410. The off-gas and fines are conducted to off-gas cyclones 418. The off-gas cyclones 418 separate the majority of the fines from the air, and the fines are withdrawn from the bottom of the cyclones 418 while the air exits from the top of the cyclones. The intake of the blower 412 is connected to the gas outlet of the off-gas cyclones 418 to provide the suction which conducts the fine ore materials from the ablation unit 402 to the off-gas cyclones. In this way, the off-gas air is recycled back to the ablation unit 402. A purge stream duct 440, extending off the duct which connects the off-gas cyclones 418 gas outlet to the intake of blower 412, permits purging of the ingress air from the system, and helps avoid the buildup in the system of ultrafine ore particles which were not removed by the off-gas cyclones 418. The purge stream is sent to a baghouse 442 to remove the ultrafines prior to discharging the clean air to atmosphere via baghouse fan 444. The purpose of recycling the majority of the air is to reduce the size and cost of the baghouse required to treat the air stream being emitted to atmosphere.

The coarse ore materials fall to the bottom of the ablation unit 402. The bottom of the unit 402 is configured in a manner similar to the bottom of a hopper. A threshold amount of coarse ore materials is allowed to build up at the bottom of the unit 402. In an embodiment, this buildup of material may create a seal that inhibits the egress of air from the bottom of unit 402. The bottom is configured accommodate this build-up of coarse ore material up to a certain threshold amount. The bottom of the unit 402 is also configured to remove the coarse ore material from the unit 402, and to maintain the threshold amount of material at the bottom of unit 402. A first conveyor belt 424 is positioned at (which may include being connected to) the bottom of the ablation unit 402 to withdraw the coarse ore materials from the bottom of the unit 402. The first conveyor belt 424 transports the coarse ore materials to the bottom of the bucket elevator 430 for transportation to the top of the feed hoppers 432. In this way, the coarse material handling system 420 returns the coarse fraction back into feeders 432. This allows the coarse ore materials to be recycled to the ablation unit 402 for further processing one or more times. At the end of an ore processing cycle, coarse ore may be removed from the system 400 via conveyor belt 424 and waste conveyor belt 428. The entire process is repeated for each subsequent cycle.

Fluidized bed jet mills (FBJM) are conventionally used to indiscriminately grind all solid particles that are introduced into the mill to a threshold size or less. For example, conventional FBJMs are used for fine grinding of chemicals to sub 50 microns. In a conventional process, the material to be milled is fed into the FBJM to become fluidized particles through interaction with several high velocity air jets. The air jets circulate the particles causing them to collide. The milling gas, now laden with smaller, ground, particles, rises to the top of the unit and into a classifier wheel. Particles meeting a threshold fineness pass through the classifier and exit the FBJM for collection. Coarse particles that are still too large are rejected by the classifier and fall back into the fluidized bed for further circulation and grinding. For coarse particles, this cycle repeats until they meet the threshold fineness and can exit the fluidized bed jet mill via the classifier. In conventional FBJMs, all materials introduced into the mill are ground down to at least the threshold size and exit the mill via the classifier as fines. The fluidized bed jet mill may be continuously operated by continuously introducing a stream of material to be milled.

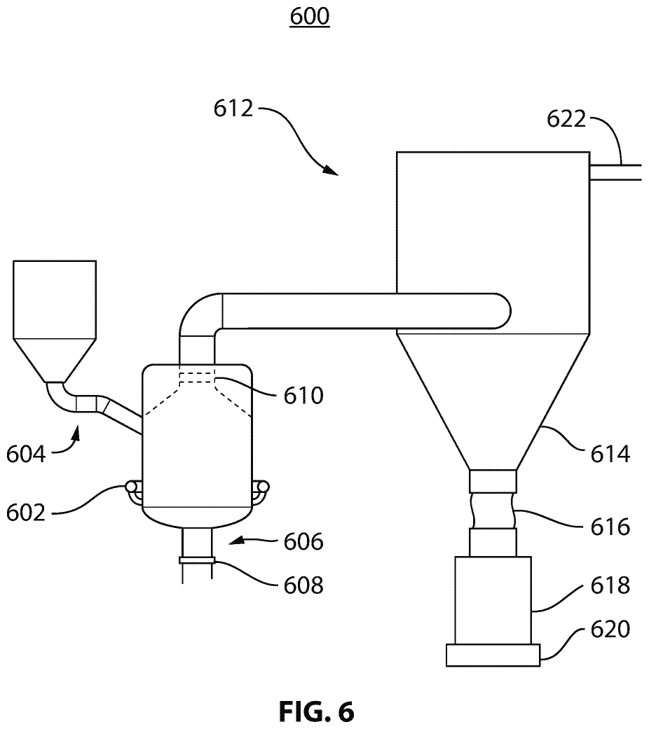

FIG. 6 shows a modified fluidized bed jet mill system (FBJM) 600 in accordance with an embodiment of the present disclosure. The FBJM 600 is modified to facilitate a dry ablation process for enriching ore, similar to the processes described in relation to the systems of FIGS. 2 to 5. The FBJM 600 is configured to selectively mill the cementing materials so as to preferentially break the bonds of cementing material particles rather than the bonds holding together the gangue grains. The FBJM 600 may also be configured to allow for the removal of a build-up of gangue grains as coarse material from the mill. The FBJM 600 comprises an air supply bustle 602, a material feeder 604, a bottom outlet 606 comprising a coarse material removal device 608, an integral classifier 610, and a fines collector 612. Alternatively, instead of a bottom outlet 606, the FBJM 600 may comprise an outlet located in its side, below the top of the bed level but above the dead zone at the bottom of the bed, for withdrawal of coarse material. In the case of a bottom outlet or side outlet for removal of coarse materials, a device for controlling the flow of materials from the outlets may be used, such as mechanical or non-mechanical valves, or some combination thereof.

In an embodiment, the conventional FBJM operation is modified to provide for preferential dry ablation of cementing materials, instead of complete comminution of all types of material in the mill. More specifically, the operating parameters of the FBJM 600 are selected to enable preferential grinding of the cementing material and preferential breakage of cementing material bonds, over the breakage of bonds holding together the gangue grains. The operating parameters of the FBJM may be such that the kinetic energy of the particles at the time of their collisions is at or below a threshold level (also referred to as a threshold velocity) which avoids fracture and/or grinding of gangue grains. Those operating parameters may include one or more of air jet velocity, air pressure, temperature, and residence time of ore materials in the mill. Fine particles (comprising the desirable material) exit through the integral classifier 610, while the coarse particles (comprising gangue grains) exit through an outlet in the bottom 606 of the FBJM. The coarse particles may be periodically removed from the outlet provided in the bottom 606 of the FBJM using the coarse material removal device 608. In this way, the modified FBJM 600 may feed new ore material on a semi-continuous basis. The rate at which new material is fed into the modified FBJM 600 decreases over time in order to maintain a relatively constant bed level. This is because the breakdown of coarse material comprising gangue grains is minimized, which results in the gangue grains accumulating in the bed as coarse material. This would cause a decline in the rate of fine generation over time as the portion of the bed material represented by the gangue grains (relative to the cementing material) increases over time. At a threshold fine production rate, all or a portion of the material in the bed would be removed from the unit through the opening in the bottom 606 as a means of purging the accumulated coarse gangue grains, and the feed rate of new material would be ramped up to return the level of material in the bed back to the desired level.

The classifier may be a static or dynamic classifier. An example of a dynamic classifier is a classifier comprising a spinning wheel. The classifier may be an integral classifier located within the FBJM 600.

The use of the modified fluidized bed jet mill 600 for ablating ore avoids external recirculation of coarse materials outside of the fluidized bed jet mill 600. This helps reduce the amount of time that passes between collisions of a particular particle of ore. It also helps reduce the size and complexity of the supporting infrastructure needed to recirculate coarse materials. The modified FBJM 600 may also help reduce the air-to-solids ratio required for dry ablation. Less air wastage leads to lower gas flow requirements, and smaller gas handling equipment.

The fine particles, which exit with off-gas through the integral classifier 610, are conducted to a fines collection device 614, such as a cyclone or baghouse, which separates the fines from the off-gas. A gas outlet 622 extends from the fines collection device 614. While the cleaned air is expelled via the gas outlet 622, the fines which have been separated from that air, descend through an expansion joint 616 into a fines collection bin 618. The fines produced by the FBJM 600 may be monitored to control the operation of the FBJM 600. For example, the production rate of the fines may be monitored. The FBJM 600 may comprise a fine particle monitor 620 to help determine the amount of fines being produced and/or collected over time. The monitor 620 may be located in the fines collection bin. The FBJM 600 may be controlled in response to a threshold amount of fines detected by the monitor 620.

In an embodiment, the fluidized bed jet mill 600 is emptied of its coarse materials in response to a period of time passing, or in response to the rate at which fines are produced/generated reaching a lower threshold rate. The period of time may be based upon the time at which the fluidized bed jet mill 600 was last emptied of its coarse materials. The fine particle monitor 620 may be used to determine the rate at which fines are produced by the mill. The monitor 620 may be a load cell that measures the rate of change of the weight of fine particles that have been collected in the fines collection bin 618. The fine particles may be collected in a baghouse, and the load cell may be positioned at the fines collection bin 618 at the bottom of the baghouse. Alternatively, the fine particle monitor may be an opacity monitor which monitors the density of particulate matter in the off-gas of the mill, such as the off-gas stream which exits the classifier. Other actions may be taken in response to the detecting, using the monitor, a lower threshold production rate of fine particles. Those other actions may include, for example, reducing or stopping the acceleration of air and/or providing ore particles in the fluidized bed jet mill 600. Another action may be to cause the bottom or side outlet of the fluidized bed jet mill to open.

Embodiments of the present disclosure are not limited to processing sandstone hosted uranium ores. The embodiments may be used to process other ore types where the desired material is a sub-component of a cementing material that is bound to gangue grains. Accordingly, the embodiments of this disclosure may be used to upgrade ores with metal deposits formed by mineralization, such as uranium and lithium. They may also be used polish granular material. Embodiments of the present disclosure may also be used to process existing stockpiles of low-grade ore material that were previously considered not viable for processing using conventional methods and systems.

We claim:

1. A method for enriching ore, comprising:
providing a gas stream;
providing ore particles into the gas stream, the ore particles comprising cementing material bound to gangue grains;
colliding the ore particles in the gas stream to break the cementing material; and
separating a fine fraction comprising the broken cementing material, from a coarse fraction comprising the gangue grains.

2. The method of claim 1, further comprising providing a second gas stream, and providing ore particles into the second gas stream, wherein colliding the ore particles in the gas stream comprises colliding with the ore particles in the second gas stream.

3. The method of claim 1, further comprising providing a strike surface, and wherein colliding the ore particles in the gas stream comprises colliding the ore particles with the strike surface.

4. The method of claim 1, wherein colliding the ore particles comprises colliding the ore particles with each other.

5. The method of claim 4, further comprising stopping collision of the ore particles in response to reaching a threshold rate of production of the fine fraction.

6. The method of claim 1, wherein the ore particles are provided into the gas stream after acceleration of the gas stream.

7. The method of claim 1, further comprising emitting the gas stream from a nozzle, and wherein the ore particles are provided into the gas stream downstream from the outlet of the nozzle.

8. The method of claim 1, wherein the ore particles are provided into the gas stream using the force of gravity.

9. The method of claim 1, wherein the fine fraction is separated from the coarse fraction based on a difference in particle sizes.

10. The method of claim 1, wherein the fine fraction is separated from the coarse fraction using a classifier.

11. The method of claim 1, wherein providing ore particles into the gas stream comprises providing the coarse fraction of the ore particles back into the gas stream.

12. The method of claim 1, wherein providing the gas stream comprises accelerating the gas stream to a velocity that is less than a threshold velocity required to break the bonds holding at least a portion of the gangue grains together when colliding the ore particles in the gas stream.

13. An ore ablation system, comprising:
a feeder configured to provide ore particles, the ore particles comprising a cementing material bound to gangue grains;
a nozzle configured to provide a first gas stream which collides the ore particles entrained within the first gas stream to break the cementing materials; and
a classifier configured to separate a fine fraction comprising the broken cementing material, from a coarse fraction comprising the gangue grains.

14. The ore ablation system of claim 13, further comprising an enclosure for receiving the ore particles and the first gas stream.

15. The ore ablation system of claim 13, further comprising a second nozzle configured to provide a second gas stream that intersects with the path of the first gas stream to collide the ore particles entrained within the first and second gas streams.

16. The ore ablation system of claim 13, further comprising a strike surface positioned within the path of the first gas stream.

17. The ore ablation system of claim 13, further comprising a blower configured to provide the first gas stream to the nozzle.

18. The ore ablation system of claim 13, wherein the feeder is configured to provide the ore particles into the first gas stream downstream of the nozzle.

19. The ore ablation system of claim 13, wherein the feeder is configured to provide the ore particles into the first gas stream upstream of the nozzle.

20. The ore ablation system of claim 13, wherein the classifier is a static classifier or a dynamic classifier.

21. The ore ablation system of claim 13, wherein the outlet of the feeder is positioned above the first gas stream.

22. The ore ablation system of claim 13, further comprising a coarse material handling system configured to return the coarse fraction back into the feeder.

23. A fluid bed jet mill comprising a classifier configured to permit only fine particles to exit the mill, and an outlet configured to permit coarse particles to exit the mill.

24. The fluid bed jet mill of claim 23, wherein the outlet is located in the bottom of the mill.

25. The fluid bed jet mill of claim 23, wherein the outlet is located in the side of the mill.

26. A method for enriching ore particles, comprising:
providing the ore particles into a fluid bed jet mill, the ore particles comprising cementing material bound to gangue grains;
preferentially milling the cementing material rather than the gangue grains in the fluid bed jet mill; and
passing a fine fraction comprising the broken cementing material through a classifier.

27. The method of claim 26, further comprising removing a coarse material from the mill.

28. The method of claim 27, wherein coarse material is removed from the mill in response to reaching a threshold period of time.

29. The method of claim 26, wherein preferentially milling the cementing material comprises controlling the operation of the fluid bed jet mill to collide the ore particles with each other in the fluid bed jet mill at a velocity that is less than a threshold velocity required to break the bonds holding together at least a portion of the gangue grains.
